(19) United States
(12) Patent Application Publication
(10) Pub. No.: US 2026/0341239 A1
(43) Pub. Date: Oct. 29, 2026

(54) DISPLAY APPARATUS

(71) Applicant: LG Display Co., Ltd., Seoul (KR)

(72) Inventors: Seung Taek OH, Paju-si, (KR); Sun Yeop KIM, Paju-si (KR)

(73) Assignee: LG Display Co., Ltd., Seoul (KR)

(21) Appl. No.: 19/630,948

(22) Filed: Mar. 27, 2026

(30) Foreign Application Priority Data
Apr. 24, 2025 (KR) 10-2025-0053668

(51) Int. Cl. G09G 3/34; F21V 8/00; G09G 3/36

(52) U.S. Cl. CPC G09G 3/3406; G02B 6/0055; G09G 3/3688; G09G 3/3696; G09G 2300/0465; G09G 2300/0842; G09G 2320/0233; G09G 2320/0257

(57) ABSTRACT

A display apparatus includes a liquid crystal panel including a normal area, a dark area and an under-camera display (UDC) area in which a plurality of subpixels are provided, an optical sheet disposed on a backside surface of the liquid crystal panel, a backlight light guide plate disposed on a backside surface of the optical sheet, a reflector disposed on a backside surface of the backlight light guide plate and including a reflector hole, an optical module disposed on a backside surface of the reflector and configured to detect external light through the reflector hole, and a data driver configured to supply a data voltage based on digital image data to the plurality of subpixels in response to a scan signal.

### CROSS-REFERENCE TO RELATED APPLICATIONS

This application claims the benefit of the Korean Patent Application No. 10-2025-0053668, filed on Apr. 24, 2025, which is hereby incorporated by reference as if fully set forth herein.

### BACKGROUND

### Field of the Disclosure

The present disclosure relates to a display apparatus.

### Discussion of the Related Art

Generally, display apparatuses provide an image to a user. For example, display apparatuses may include a liquid crystal panel which is disposed on a backlight unit. The liquid crystal panel may generate an image by using light supplied from the backlight unit. For example, the liquid crystal panel may include subpixels.

An optical module including an optical camera such as an RGB camera or an infrared (IR) sensor camera for detecting external light incident on the liquid crystal panel may be provided on a backside surface of the liquid crystal panel.

As described above, in a case where the optical module is provided on the backside surface of the liquid crystal panel, a transmittance of a subpixel disposed in an under-camera display (UDC) area, where the optical module is provided, of the liquid crystal panel may differ from that of a subpixel of the liquid crystal panel disposed in a normal area where the optical module is not provided.

Due to such a transmittance difference between subpixels described above, a sense of difference and a visual difference may occur in an image displayed on the liquid crystal panel.

Moreover, an optical sheet provided on the backside surface of the liquid crystal panel may include a through hole which is wider than the UDC area, and due to this, a dark area where an image is relatively darkly displayed may occur between the normal area and the UDC area.

Therefore, in a case where the optical module is provided on the backside surface of the liquid crystal panel, there is a problem where the image quality of the liquid crystal panel is degraded.

### SUMMARY

Accordingly, the present disclosure is directed to a display apparatus that substantially obviates one or more problems due to limitations and disadvantages of the related art. An object of the present disclosure includes, for example, providing a display apparatus which may suppress or reduce a visual difference of a dark area disposed between a normal area and an under-camera display (UDC) area.

To achieve these objects and other advantages and in accordance with the purpose of the disclosure, as embodied and broadly described herein, a display apparatus includes a liquid crystal panel including a normal area and a dark area and a UDC area disposed to be surrounded by the normal area, a plurality of subpixels being provided in each of the normal area, the dark area, and the UDC area, an optical sheet disposed on a backside surface of the liquid crystal panel and including a sheet hole passing through the optical sheet to correspond to the dark area, a backlight light guide plate disposed on a backside surface of the optical sheet and configured to supply light of a main light source disposed therein to the liquid crystal panel, a reflector disposed on a backside surface of the backlight light guide plate and including a reflector hole with an open portion corresponding to the UDC area, an optical module disposed on a backside surface of the reflector and configured to detect external light through the reflector hole, and a data driver configured supply a data voltage based on digital image data to the plurality of subpixels in response to a scan signal, wherein the data driver includes a multi digital gamma processing unit including a first digital gamma processing unit configured to perform first gamma compensation on a data signal supplied to a subpixel disposed in each of the normal area and the UDC area, among the plurality of subpixels, to output first image data and a second digital gamma processing unit configured to perform second gamma compensation on a data signal supplied to a subpixel disposed in the dark area, among the plurality of subpixels, to output second image data.

The data driver may further comprise an analog gamma processing unit, a range from a minimum voltage to a maximum voltage of the analog gamma processing unit on the first image data based on the first gamma compensation may differ from a range from a minimum voltage to a maximum voltage of the analog gamma processing unit on the second image data based on the second gamma compensation.

A maximum voltage of the first image data based on the first gamma compensation may be less than a maximum voltage of the second image data based on the second gamma compensation.

A luminance of a maximum gray level of the first image data based on the first gamma compensation may be less than a luminance of a maximum gray level of the second image data based on the second gamma compensation.

An aperture ratio of the subpixel disposed in the UDC area may be greater than an aperture ratio of the subpixel disposed in each of the normal area and the dark area.

An aperture ratio of the subpixel disposed in the dark area may be equal to an aperture ratio of the subpixel disposed in the normal area.

An area ratio of a white subpixel including no color filter among the plurality of subpixels disposed in the UDC area may be greater than an area ratio of a white subpixel including no color filter among the plurality of subpixels disposed in the normal area and the dark area.

The display apparatus may further include an auxiliary light source disposed on the backside surface of the reflector and configured to supply light at least to the UDC area among the normal area, the UDC area, and the dark area.

Brightness of the main light source may be set based on the dark area so that a maximum gray level of the subpixel disposed in the dark area has luminance which is previously set.

Brightness of the auxiliary light source may be set so that a luminance of a maximum gray level of the subpixel disposed in the UDC area is equal to a luminance of a maximum gray level, set by the main light source, of the subpixel disposed in the normal area.

The multi digital gamma processing unit may be included in an image processing unit disposed between a timing controller configured to output digital image data and an analog gamma processing unit configured to convert the digital image data into an analog data voltage.

The multi digital gamma processing unit may be disposed between a camera pattern compensation unit configured to compensate for display smear when capturing an image with a camera and an error diffusion unit configured to distribute errors, caused by a limitation of the number of bits, to adjacent pixels.

The display apparatus may further include a selection switch disposed at a rear end of each of the first and second digital gamma processing units and configured to select one output from among an output of the first digital gamma processing unit and an output of the second digital gamma processing unit.

The data driver may be configured to supply a data voltage based on the first image data or a data voltage based on the second image data through a first data line, may be configured to output, through the first data line, the data voltage based on the first image data to the subpixel disposed in the UDC area in response to a first scan signal, may be configured to output, through the first data line, the data voltage based on the second image data to the subpixel disposed in the dark area in response to a second scan signal, and may be configured to output, through the first data line, the data voltage based on the first image data to the subpixel disposed in the normal area in response to a third scan signal.

When gray levels of the first and second image data are equal to each other, a data voltage based on the second image data may differ from a data voltage based on the first image data.

The display apparatus according to an example embodiment of the present disclosure may include a first digital gamma processing unit which performs first gamma compensation on subpixels disposed in a normal area and a UDC area and a second digital gamma processing unit which performs second gamma compensation on subpixels disposed in a dark area, and thus, may compare the normal area with the UDC area through the second digital gamma processing unit to improve a luminance of the dark area relatively darkly displayed compared to the normal area and the UDC area by using the second digital gamma processing unit, thereby suppressing or reducing a sense of difference and a visual difference of an image displayed on the dark area.

In more detail, the display apparatus according to an example embodiment of the present disclosure may allow a luminance of a maximum gray level, which is greater than a luminance of a maximum gray level provided through the first digital gamma processing unit, to be provided through the second digital gamma processing unit, thereby reducing or suppressing a sense of difference and a visual difference of an image displayed on the dark area.

### BRIEF DESCRIPTION OF THE DRAWINGS

The accompanying drawings, which are included to provide a further understanding of the disclosure and are incorporated in and constitute a part of this application, illustrate example embodiment(s) of the disclosure and together with the description serve to explain the principle of the disclosure. In the drawings:

FIG. 1 is a diagram schematically illustrating a display apparatus according to an example embodiment of the present disclosure;

FIG. 2A is a cross-sectional view taken along line A1-A1′ in FIG. 1, and FIG. 2B is an enlarged view of an under-camera display (UDC) area and a dark area in a display area;

FIG. 3 is a diagram illustrating a circuit of a subpixel disposed in a liquid crystal panel in a display apparatus according to an example embodiment of the present disclosure;

FIG. 4 is an enlarged view of region K1 illustrated in FIG. 2A;

FIG. 5 is an enlarged view of region K2 in FIG. 1;

FIG. 6 is a diagram for describing an example of a cross-sectional surface taken along each of line A2-A2′ and line A3-A3′ in FIG. 5;

FIG. 7 is a diagram for describing an example of a cross-sectional surface taken along line A4-A4′ in FIG. 5;

FIG. 8 is a diagram for describing an example of a data driver illustrated in FIG. 1;

FIG. 9 is a diagram for describing an example of an analog gamma processing unit illustrated in FIG. 8;

FIG. 10A to FIG. 10D are diagrams illustrating an example for describing first and second gamma compensations processed by a multi digital gamma processing unit illustrated in FIG. 8 when a liquid crystal panel operates in a normally black mode;

FIG. 11A to FIG. 11D are diagrams illustrating another example for describing first and second gamma compensations processed by the multi digital gamma processing unit illustrated in FIG. 8 when the liquid crystal panel operates in a normally white mode;

FIG. 12 is a diagram for describing an example of each of first and second data drivers differently provided based on positions connected to the liquid crystal panel illustrated in FIG. 1;

FIG. 13 is a diagram for describing an example of image data supplied by the first and second data drivers illustrated in FIG. 12; and

FIG. 14A and FIG. 14B are a diagram for describing an effect of a multi digital gamma processing unit provided in the present disclosure.

### DETAILED DESCRIPTION

The purpose, technical configuration, and effects based thereon of the present disclosure will be more clearly understood by the detailed description below, which refers to the drawings illustrating example embodiments of the present disclosure. Here, example embodiments of the present disclosure are provided to sufficiently transfer the technical concept of the present disclosure to those skilled in the art, and thus, the present disclosure may be embodied in other forms without being limited to the embodiments described below.

Moreover, parts referred to by like reference numeral throughout the specification denote like elements, and the lengths and thicknesses of layers or regions in the drawings may be exaggerated for convenience. Moreover, when it is described that a first element is “on” a second element, this includes not only a case where the first element being disposed on the upper side of the second element and in direct contact with the upper side of the second element, but also a case where a third element is disposed between the first and second elements.

Here, the terms “first,” “second,” etc., are for describing various elements and are used to distinguish one element from another element. However, within the scope that does not depart from the technical concept of the present disclosure, the first element and the second element may be arbitrarily named according to the convenience of those skilled in the art.

The terms used herein are used merely to describe specific example embodiments and are not intended to limit the present disclosure. For example, an element expressed in the singular includes a plurality of elements unless it is clearly understood from the context that only a singular element is intended. Furthermore, in the present disclosure, the terms “include” or “have” should be understood as specifying the presence of the features, numbers, steps, actions, elements, parts, or combinations thereof described herein, without precluding the possibility of the presence or addition of one or more other features, numbers, steps, actions, elements, parts, or combinations thereof.

Furthermore, unless otherwise defined, all terms used herein, including technical or scientific terms, have the same meaning as generally understood by one skilled in the art to which the present disclosure pertains. Terms defined in commonly used dictionaries should be construed to have meanings consistent with their context in the relevant technology and should not be construed in an idealized or overly formal sense unless explicitly defined herein.

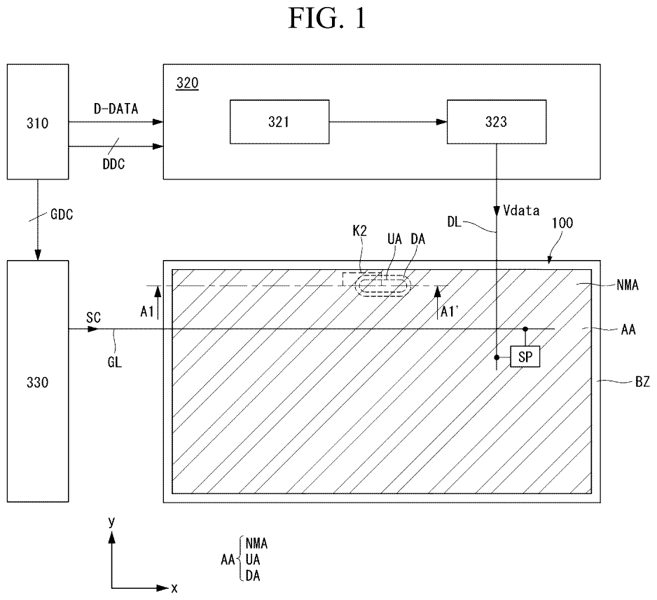

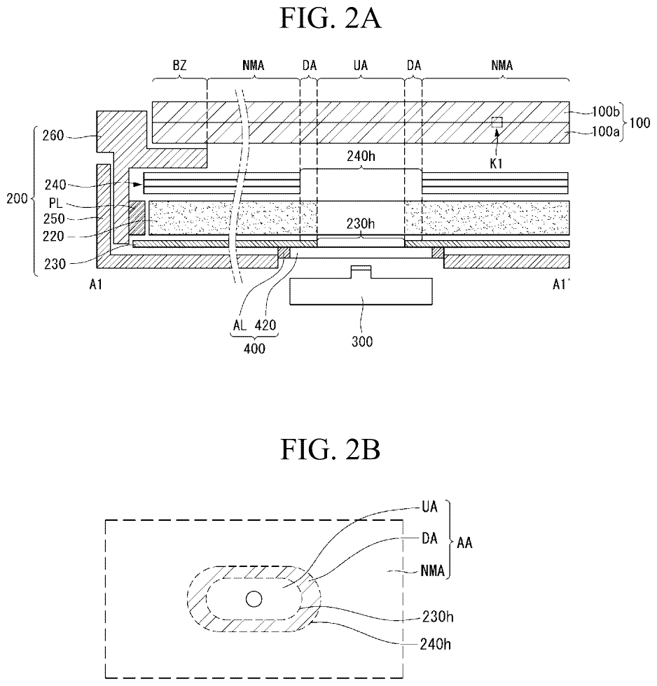

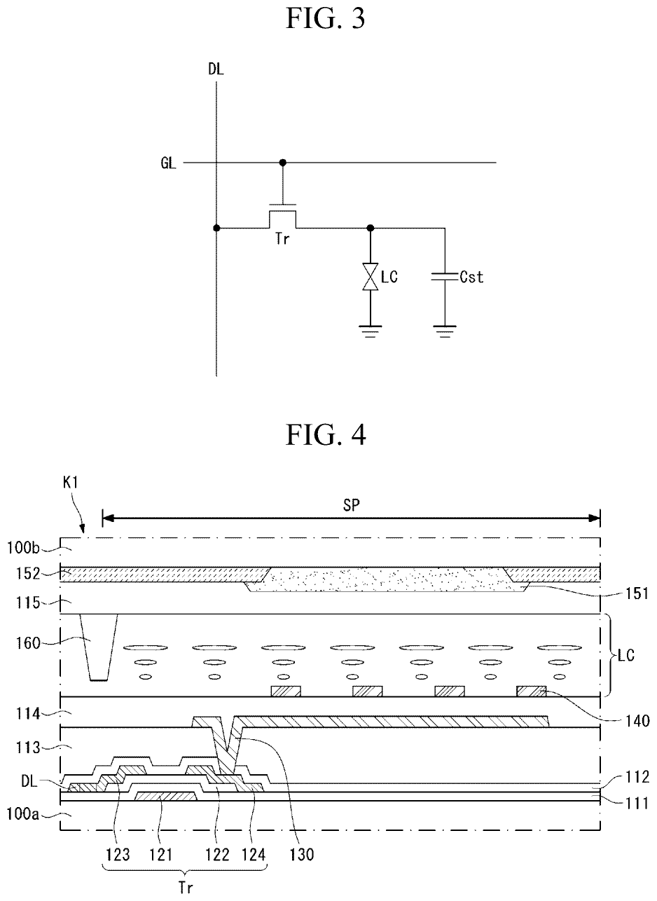

FIG. 1 is a diagram schematically illustrating a display apparatus according to an example embodiment of the present disclosure. FIG. 2A is a cross-sectional view taken along line A1-A1′ in FIG. 1, and FIG. 2B is an enlarged view of an under-camera display (UDC) area and a dark area in a display area. FIG. 3 is a diagram illustrating a circuit of a subpixel disposed in a liquid crystal panel in a display apparatus according to an example embodiment of the present disclosure. FIG. 4 is an enlarged view of region K1 illustrated in FIG. 2A.

Referring to FIGS. 1 to 4, the display apparatus according to an example embodiment of the present disclosure, as illustrated in FIG. 1, may include a liquid crystal panel 100, a timing controller 310, a data driver 320, and a scan driver 330.

The timing controller 310 may generate timing control signals DDC and GDC based on RGB digital image data D-DATA input from a host system (not shown) and may supply the timing control signals DDC and GDC to the data driver 320, the scan driver 330, and a power supply circuit (not shown). The timing controller 310 may receive a timing signal such as a vertical synchronization signal, a horizontal synchronization signal, a data enable signal, and a dot clock from the host system to generate the timing control signals GDC and DDC for controlling operation timings of the scan driver 330 and the data driver 320.

The timing control signals GDC and DDC may include a gate timing control signal GDC for controlling the operation timing of the scan driver 330, a data timing control signal DDC for controlling the operation timing of the data driver 320, and a power timing control signal (not shown) for controlling an operation timing of the power circuit.

The timing controller 310 may supply digital image data to the data driver 320 to allow an image to be displayed on the liquid crystal panel 100.

The host system (not shown) may be an application processor which is provided in one of a television (TV), a set-top box, a navigation system, a personal computer, a mobile device, a wearable device, and a virtual/augmented reality device. However, the host system is not limited thereto.

The data driver 320 may receive digital image data D-DATA from the timing controller 310, may convert the digital image data D-DATA into an analog data voltage Vdata, and may supply the analog data voltage Vdata to the subpixels connected thereto through a data line DL.

The data driver 320 may perform operations such as gamma compensation on the digital image data D-DATA received from the timing controller 310 by using the image processing unit 321, may convert gamma compensation-performed digital image data into the analog data voltage Vdata by using a digital-to-analog converter (DAC) 323, and may supply the analog data voltage Vdata through a data line DL.

To this end, the data driver 320 may be implemented with a plurality of data drive integrated circuits (ICs) electrically connected to a bezel area BZ of the liquid crystal panel 100.

The analog data voltage Vdata may be supplied to a plurality of subpixels SP which are provided in the liquid crystal panel 100, in response to the scan signal SC supplied through a scan line GL.

The scan driver 330 may generate the scan signal SC based on the gate timing control signal GDC received from the timing controller 310 and may supply the scan signal SC to each subpixel SP provided in the liquid crystal panel 100.

The power supply circuit (not shown) may process input power according to a power timing control signal input from the timing controller 310, may generate a high-level driving voltage and a low-level driving voltage which are to be supplied to each subpixel, and may supply the high-level driving voltage and the low-level driving voltage to the scan driver 330.

The liquid crystal panel 100 may generate an image provided to the user. For example, the liquid crystal panel 100 may include the plurality of subpixels SP.

Various signals may be applied to each subpixel SP through signal lines GL and DL. For example, the signal lines GL and DL may include the scan lines GL which sequentially transfer the scan signal SC and the data lines DL which transfer the analog data voltage Vdata. The scan lines GL may intersect with the data lines DL.

For example, the scan lines GL may extend in a first direction x, and the data lines DL may extend in a second direction y perpendicular to the first direction x.

The liquid crystal panel 100 may include a display area AA where subpixels SP for displaying an image are disposed and a bezel area BZ disposed outside the display area AA.

The bezel area BZ may not include the subpixels SP, or may include dummy subpixels which do not display an image and may include the scan driver 330 or the data driver 320.

The display area AA may be surrounded by the bezel area BZ. The scan driver 330 electrically connected to the scan lines GL and the data driver 320 electrically connected to the data lines DL may be connected to and disposed in the bezel area BZ. For example, each of the signal lines GL and DL may include an area overlapping the bezel area BZ of the liquid crystal panel 100.

The display area AA may include a normal area NMA, a dark area DA, and an under-camera display area UA. The Normal Area NMA, the dark area DA, and the under-camera display area UA will be described in detail after first describing the backlight unit 200.

The backlight unit 200, as illustrated in FIG. 2A and FIG. 2B, may be disposed on a backside surface of the liquid crystal panel 100 and may include a main light source PL, a backlight light guide plate 220, a reflector 230, an optical sheet 240, a cover bottom 250, and a middle frame 260. An optical module 300 and an auxiliary light source AL module 400 may be provided on the backside surface of the backlight unit 200.

The main light source PL may supply light to the liquid crystal panel 100 through the backlight light guide plate 220. For example, the main light source PL may be disposed on a side surface of the backlight light guide plate 220. The main light source PL may include a self-emitting device capable of generating and emitting light. For example, the main light source PL may include a light emitting diode (LED).

The backlight light guide plate 220 may be disposed on the backside surface of the liquid crystal panel 100 and may include a dispersion pattern such as a mesh pattern which allows the light from the main light source PL to be uniformly scattered toward the liquid crystal panel 100.

To enhance the external light detection of the optical module 300, a dispersion pattern may not be provided in a portion of the backlight light guide plate 220 overlapping the UDC area UA. Depending on the case, a dispersion pattern may not be provided in a portion of the backlight light guide plate 220 overlapping the dark area DA.

The reflector 230 may be disposed on a bottom surface of the backlight light guide plate 220 and may reflect light scattered from the backlight light guide plate 220 toward the liquid crystal panel 100.

The reflector 230 may include a material capable of reflecting light. For example, the reflector 230 may include metal such as aluminum (Al) and silver (Ag).

The reflector 230 may include a reflector hole 230h where a portion thereof is opened. The reflector hole 230h may be disposed in a portion overlapping the UDC area UA, and the optical module 300 may be exposed through the reflector hole 230h. The optical module 300 may detect external light through the reflector hole 230h and a sheet hole 240h.

The optical sheet 240 may be disposed between the backlight light guide plate 220 and the liquid crystal panel 100. Light supplied to the liquid crystal panel 100 through the backlight light guide plate 220 may overall have uniform luminance based on a plurality of optical sheets 240.

The optical sheet 240, for example, may have a stack structure including a prism sheet and a diffusion sheet which are stacked.

The diffusion sheet may scatter light guided by the backlight light guide plate 220 to irradiate the scattered light toward the prism sheet and the liquid crystal panel 100, thereby widening a viewing angle. The diffusion sheet may prevent or suppress a dispersion pattern such as a mesh pattern provided in the backlight light guide plate 220 from appearing on a display screen of the liquid crystal panel 100.

In a process where light passes through the diffusion sheet and spreads, a phenomenon where luminance or brightness rapidly decreases may occur. The prism sheet may refract and collect the light again, thereby increasing luminance or brightness. To this end, a plurality of prisms may be provided on a cross-sectional surface of the prism sheet.

Accordingly, light passing through the diffusion sheet and the prism sheet may be uniformly supplied to an entire area of the liquid crystal panel 100. The optical sheet 240 including the diffusion sheet and the prism sheet may include the sheet hole 240h in a portion overlapping the dark area DA and the UDC area UA, to enhance a transmittance in the UDC area UA and maximize or increase external light detection by the optical module 300.

The cover bottom 250 may provide a space which accommodates the main light source PL, the backlight light guide plate 220, the reflector 230, and the optical sheet 240.

The cover bottom 250 may include an insulating material. For example, the cover bottom 250 may include plastic. The cover bottom 250 may include a bottom surface and a sidewall protruding from an edge of the bottom surface.

The main light source PL, the backlight light guide plate 220, the reflector 230, and the optical sheet 240 may be disposed in a space formed by the bottom surface and the sidewall of the cover bottom.

The bottom surface of the cover bottom may include a cover hole which is formed to pass through a portion thereof, so that the optical module 300 is disposed therein.

The middle frame 260 may support the liquid crystal panel 100. The middle frame 260 may be coupled to the cover bottom 250. For example, the middle frame 260 may include a coupling region extending between the cover bottom 250 and the backlight light guide plate 220. The main light source PL may be fixed to the coupling region of the middle frame 260.

For example, the main light source PL may be attached to the coupling region of the middle frame 260 by an adhesive member. The middle frame 260 may include a placement region extending between the optical sheet 240 and the liquid crystal panel 100.

The placement region of the middle frame 260 may overlap the edge of the optical sheet 240. For example, the placement region of the middle frame 260 may overlap the bezel area BZ of the liquid crystal panel 100. The display area AA of the liquid crystal panel 100 may not overlap the placement region of the middle frame 260.

The optical module 300 may be disposed on a backside surface of the backlight light guide plate 220 and may detect external light passing through the liquid crystal panel 100. The optical module 300 may include, for example, an optical camera such as an RGB camera or an infrared (IR) sensor camera.

The optical camera of the optical module 300 may be exposed at the UDC area UA through the cover hole, the reflector hole 230h, and the sheet hole 240h.

The auxiliary light source AL module 400 may be disposed between the optical module 300 and the backlight light guide plate 220. For example, the auxiliary light source AL module 400 may be disposed between the optical module 300 and the reflector 230.

The auxiliary light source AL module 400 may include an auxiliary light source AL and an auxiliary light guide plate 420. The auxiliary light source AL may supply light to the UDC area UA through the auxiliary light guide plate 420.

The main light source PL and the auxiliary light source AL may be turned on while an image is being displayed on the display area AA, and moreover, may be turned off for external light detection by the optical module 300 while the optical module 300 is operating.

As described above, the display area AA in the liquid crystal panel 100 may include the normal area NMA, the dark area DA, and the UDC area UA.

In the liquid crystal panel 100, the UDC area UA may be an area overlapping the reflector hole 230h of the reflector 230, and the optical module 300 may be exposed through the reflector hole 230h in the UDC area UA. The optical module 300 may detect external light through the UDC area UA.

In the liquid crystal panel 100, the dark area DA may surround the UDC area UA and may be the other area, except the UDC area UA overlapping the reflector hole 230h, of an area overlapping the sheet hole 240h of the optical sheet 240. The reflector holes 230h may be exposed in the dark area DA. The optical sheet 240 may not be disposed in the dark area DA, and the reflector 230 may be disposed in the dark area DA.

The normal area NMA may be the other area except the dark area DA and the UDC area UA.

To maximize or increase external light detection by the optical module 300, a transmittance or an aperture ratio of each of the subpixels disposed in the UDC area UA may be higher than that of each of the subpixels disposed in the dark area DA and the normal area NMA, and the aperture ratio of each of the subpixels disposed in the dark area DA may be the same as that of each of the subpixels disposed in the normal area NMA.

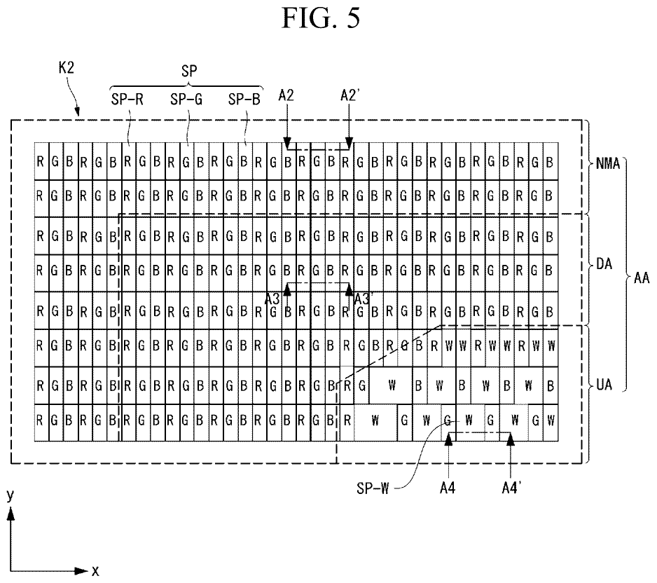

For example, R, G, and B subpixels respectively including color filters may be disposed in the normal area NMA and the dark area DA, and in addition to the R, G, and B subpixels, a white subpixel including no color filter may be further disposed in the UDC area UA. This will be described below in detail with reference to FIG. 5.

The normal area NMA and the dark area DA may mainly receive light from the main light source PL, and the UDC area UA may mainly receive light from the auxiliary light source AL. A luminance difference between subpixels caused by a difference in transmittance or aperture ratio between the normal area NMA and the UDC area UA may be solved by adjusting the brightness of the auxiliary light source AL.

For example, to implement a full white image through all of subpixels disposed in the normal area NMA and subpixels disposed in the UDC area UA, when the brightness of the main light source PL and the auxiliary light source AL are set to be equal to each other, a luminance of an image displayed on the UDC area UA may appear higher than that of an image displayed on the normal area NMA because a transmittance or an aperture ratio of the UDC area UA is relatively larger.

Considering this, the display apparatus according to example embodiments of the present disclosure may degrade the brightness of the auxiliary light source AL to minimize or reduce a luminance difference between the UDC area UA and the normal area NMA.

However, even when light from the main light source PL is provided to the dark area DA by the reflector 230, a transmittance or an aperture ratio of each of the subpixels disposed in the dark area DA is lower than that of each of the subpixels disposed in the UDC area UA, and the optical sheet 240 is not provided in the dark area DA, and thus, a luminance of the dark area DA may be relatively lower than that of the normal area NMA or the UDC area UA.

Due to such a luminance difference, a visual difference and a sense of difference may occur between an image displayed on the dark area DA and an image displayed on the normal area NMA and UDC area UA.

In the display apparatus according to an example embodiment of the present disclosure, as described above, to solve a visual difference and a sense of difference between an image displayed on the dark area DA, the brightness of the main light source PL may be set with respect to the dark area DA, and in this case, the brightness of the main light source PL may be set so that a maximum gray level of each of the subpixels disposed in the dark area DA has predetermined luminance. Accordingly, luminance corresponding to a maximum gray level of each of the subpixels disposed in the normal area NMA may also be set together.

Furthermore, the display apparatus according to an example embodiment of the present disclosure may adjust the brightness of the auxiliary light source AL so that luminance corresponding to a maximum gray level of each of the subpixels disposed in the UDC area UA is equal to luminance corresponding to a maximum gray level of each of the subpixels disposed in the normal area NMA.

As described above, in a state where the brightness of the main light source PL and the auxiliary light source AL are set, the display apparatus according to an example embodiment of the present disclosure may differently perform gamma compensation on the normal area NMA and the UDC area UA and gamma compensation on the dark area DA, thereby reducing or suppressing a visual difference and a sense of difference on an image displayed on the dark area DA.

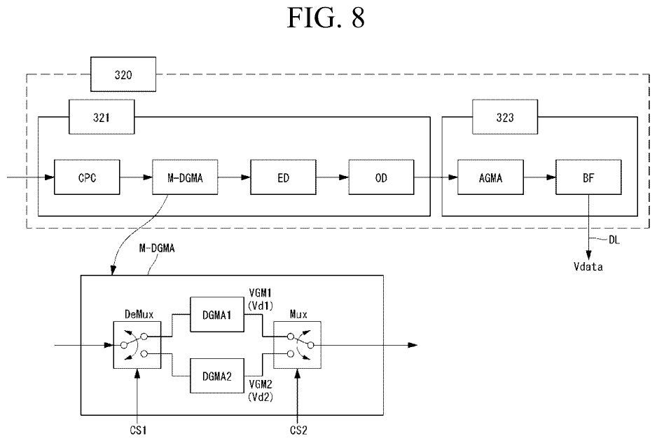

For example, a range of gamma voltage for gamma compensation on the dark area DA may be set to be relatively large, and a range of gamma voltage for gamma compensation on the normal area NMA and the UDC area UA may be set to be relatively small. This will be described below in detail with reference to FIG. 8.

Each subpixel provided in the liquid crystal panel 100, as illustrated in FIG. 3, may include a thin film transistor Tr, a liquid crystal layer LC, and a storage capacitor Cst.

The thin film transistor Tr of each subpixel may include a gate electrode connected to the scan line GL, one electrode connected to the data line DL, and the other electrode connected to a pixel electrode of the liquid crystal layer LC. The liquid crystal layer LC may include the pixel electrode connected to the other electrode of the thin film transistor Tr and the common electrode connected to a low-level voltage.

A positive electrode of the storage capacitor Cst may be connected to the pixel electrode and common electrode of the liquid crystal layer LC.

The thin film transistor Tr may generate a driving voltage corresponding to the analog data voltage Vdata applied to a corresponding subpixel SP, based on the scan signal SC applied to the corresponding subpixel SP, and may apply the driving voltage to the pixel electrode 130 of the liquid crystal layer LC. The liquid crystal layer LC may control a transmittance according to the driving voltage, and thus, may adjust and emit the amount of light incident from the main light source or the auxiliary light source AL.

The liquid crystal panel 100 may include a first display substrate 100a and a second display substrate 100b, and the first display substrate 100a and the second display substrate 100b may include an insulating material. The first display substrate 100a and the second display substrate 100b may include a transparent material. For example, the first display substrate 100a and the second display substrate 100b may include glass or plastic.

The liquid crystal layer LC, as illustrated in FIG. 4, may be disposed between the first display substrate 100a and the second display substrate 100b.

The liquid crystal layer LC may be controlled in transmittance, based on the analog data voltage Vdata, and may include liquid crystals of various modes. For example, the liquid crystal layer LC may be driven in a normally black mode where light is not transmitted in a state where the analog data voltage Vdata is not applied, or may be driven in a normally white mode where light is transmitted in a state where the analog data voltage Vdata is not applied. Hereinafter, a case where the liquid crystal layer LC is driven in the normally black mode will be described as a basic example.

The liquid crystal of the liquid crystal layer LC may be twisted by a vertical or lateral electric field formed in a corresponding subpixel SP, based on the analog data voltage Vdata. For example, the common electrode 140 overlapping a portion of the pixel electrode 130 and the pixel electrode 130 for forming the lateral electric field may be disposed in each subpixel SP.

The liquid crystal layer LC may control a transmittance of light supplied from a light source, based on a level of the analog data voltage Vdata applied thereto. For example, when the liquid crystal layer LC is driven in the normally black mode, a transmittance of the liquid crystal layer LC may increase as the level of the analog data voltage Vdata increases, and the transmittance of the liquid crystal layer LC may decrease as the level of the analog data voltage Vdata decreases.

On the other hand, when the liquid crystal layer LC is driven in the normally white mode, the transmittance of the liquid crystal layer LC may increase as the level of the analog data voltage Vdata decreases, and the transmittance of the liquid crystal layer LC may decrease as the level of the analog data voltage Vdata increases. The transmittance of the liquid crystal panel 100 may be determined by the transmittance of the liquid crystal layer LC.

A constant source voltage may be supplied to the common electrode 140 of each subpixel SP. A driving voltage corresponding to the analog data voltage Vdata applied to the data line DL of a corresponding subpixel SP may be supplied to the pixel electrode 130 of each subpixel SP according to the scan signal SC applied to the scan line GL of the corresponding subpixel SP.

The thin film transistor Tr of each subpixel SP may include a gate electrode 121 electrically connected to one of the scan lines GL, a semiconductor pattern 122 including a region overlapping the gate electrode 121, a drain electrode 123 electrically connected to one end portion of the semiconductor pattern 122, and a source electrode 124 electrically connected to the other end portion of the semiconductor pattern 122.

The gate electrode 121 may include metal such as aluminum (Al), chromium (Cr), copper (Cu), molybdenum (Mo), titanium (Ti), and tungsten (W).

The semiconductor pattern 122 may be disposed on the gate electrode 121. The semiconductor pattern 122 may include an oxide semiconductor such as amorphous silicon (a-Si), polycrystalline silicon (poly-Si), and indium gallium zinc oxide (IGZO). The semiconductor pattern 122 may include a channel region disposed between a drain region and a source region thereof.

The drain region and the source region of the semiconductor pattern 122 may have a resistance which is less than that of the channel region of the semiconductor pattern 122.

The semiconductor pattern 122 may be spaced apart from the gate electrode 121. The semiconductor pattern 122 may be insulated from the gate electrode 121. For example, the channel region of the semiconductor pattern 122 may have electrical conductivity corresponding to a voltage supplied to the gate electrode 121. The drain region of the semiconductor pattern 122 may be electrically connected to the source region of the semiconductor pattern 122, based on a signal applied to the gate electrode 121.

The drain electrode 123 and source electrode 124 may include metal such as Al, Cr, Cu, Mo, Ti, and W.

The drain electrode 123 may be electrically connected to the drain region of the semiconductor pattern 122. The source electrode 124 may be electrically connected to the source region of the semiconductor pattern 122. The drain electrode 123 and source electrode 124 may be insulated from the gate electrode 121.

The drain electrode 123 of each subpixel SP may be electrically connected to one of the data lines DL. The pixel electrode 130 of each subpixel SP may be electrically connected to the source electrode 124 of a corresponding subpixel SP.

In FIG. 4, the thin film transistor Tr and the storage capacitor Cst of each subpixel SP may be disposed between the first display substrate 100a and the liquid crystal layer LC. A plurality of insulation films 111 to 114 may be disposed between the first display substrate 100a and the liquid crystal layer LC. For example, a gate insulation layer 111, a device protection layer 112, a planarization layer 113, and an interlayer insulation layer 114 may be disposed between the first display substrate 100a and the liquid crystal layer LC.

The gate insulation layer 111 may be disposed close to the first display substrate 100a. The semiconductor pattern 122 of each subpixel SP may be insulated from the gate electrode 121 of a corresponding subpixel SP by the gate insulation layer 111. The gate insulation layer 111 may include an inorganic insulating material such as silicon oxide (SiOₓ) and silicon nitride (SiNₓ).

The device protection layer 112 may be disposed on the gate insulation layer 111. The device protection layer 112 may prevent or protect the thin film transistor Tr disposed in each subpixel SP from being damaged by external impact and water. The device protection layer 112 may include an inorganic insulating material such as SiOₓ and SiNₓ.

The planarization layer 113 may be disposed on the device protection layer 112. The planarization layer 113 may remove a step height caused by the thin film transistor Tr and the storage capacitor Cst of each subpixel SP. The planarization layer 113 may include a material having relatively high fluidity. For example, the planarization layer 113 may include an organic insulating material.

The interlayer insulation layer 114 may be disposed between the planarization layer 113 and the liquid crystal layer LC. The common electrode 140 of each subpixel SP may be insulated from the pixel electrode 130 of a corresponding subpixel SP by the interlayer insulation layer 114. For example, the interlayer insulation layer 114 may include an inorganic insulating material.

Color filters 151, a black matrix 152, and an upper passivation layer 115 may be disposed between the liquid crystal layer LC and the second display substrate 100b.

The color filters 151 may overlap the subpixels SP. For example, each color filter 151 may overlap one of the subpixels SP. Each color filter 151 may represent a specific color by using light passing through the liquid crystal layer LC. For example, light passing through each color filter 151 may represent one of red (R), blue (B), and green (G). The black matrix 152 may be disposed in parallel to the color filters 151. For example, an end portion of each color filter 151 may overlap the black matrix 152.

The black matrix 152 may include a material capable of reflecting or absorbing light. For example, light passing through the liquid crystal layer LC of each subpixel SP may be discharged to the outside via the color filter 151 of a corresponding subpixel SP disposed in a region defined by the black matrix 152.

The black matrix 152 may overlap the signal lines GL and DL. The thin film transistor Tr and the storage capacitor Cst of each subpixel SP may overlap the black matrix 152. Therefore, in the display apparatus according to an example embodiment of the present disclosure, the signal lines GL and DL and the thin film transistor Tr and the storage capacitor Cst of each subpixel SP may not be recognized by a user, based on the black matrix 152.

The upper passivation layer 115 may prevent or protect the color filters 151 and black matrix 152 from being damaged by external impact and water. The upper passivation layer 115 may include an insulating material. For example, the upper passivation layer 115 may include an inorganic insulating material such as SiOₓ and SiNₓ.

A spacer 160 may be disposed between the interlayer insulation layer 114 and the upper passivation layer 115. The spacer 160 may maintain a constant interval between the interlayer insulation layer 114 and the upper passivation layer 115. Accordingly, in the display apparatus according to an example embodiment of the present disclosure, the liquid crystal layer LC of each subpixel SP may have the same thickness.

In the display apparatus according to an example embodiment of the present disclosure, light passing through the liquid crystal layer LC of each subpixel SP may have the same luminance as that of light passing through the liquid crystal layer LC of a subpixel SP having the same lateral electric field as that of a corresponding subpixel SP.

The liquid crystal panel 100 may be disposed on the backlight unit 200. The backlight unit 200 may supply light to the liquid crystal panel 100. For example, the liquid crystal panel 100 may generate an image provided to a user by using light supplied from the backlight unit 200.

The display area AA of the liquid crystal panel 100, as described above, may include the normal area NMA, the dark area DA, and the UDC area UA.

A transmittance or an aperture ratio of each subpixel disposed in the UDC area UA may be higher than that of each subpixel disposed in the dark area DA and the normal area NMA, and the aperture ratio of each subpixel disposed in the dark area DA may be the same as that of each subpixel disposed in the normal area NMA.

To this end, a subpixel structure and color arrangement disposed in the dark area DA may be the same as a subpixel structure and color arrangement disposed in the normal area NMA. For example, a width, a length, and color arrangement of the R, G, and B subpixels disposed in the dark area DA may be equal to a width, a length, and color arrangement of the R, G, and B subpixels disposed in the normal area NMA.

In addition to the R, G, and B subpixels, a white subpixel including no color filter may be further disposed in the UDC area UA.

Hereinafter, a structure of subpixels disposed in the normal area NMA, the dark area DA, and the UDC area UA will be described with reference to FIG. 5.

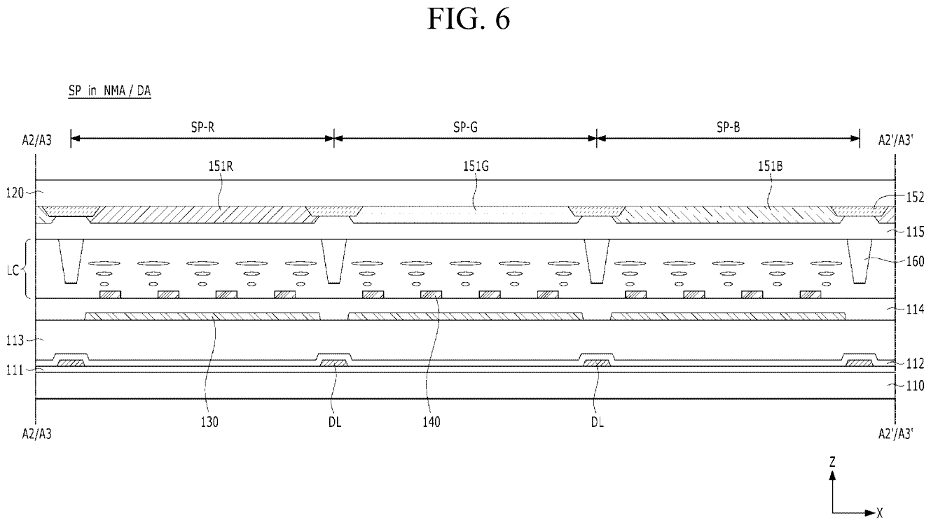

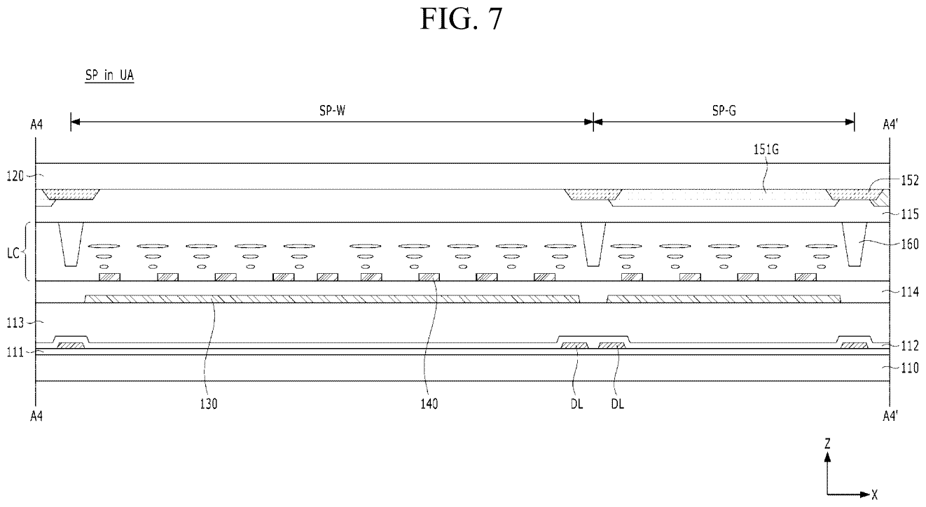

FIG. 5 is an enlarged view of region K2 in FIG. 1. FIG. 6 illustrates an example of a cross-sectional surface taken along each of line A2-A2′ and line A3-A3′ in FIG. 5, so as to describe a subpixel structure of each of the normal area NMA and the dark area DA. FIG. 7 illustrates an example of a cross-sectional surface taken along line A4-A4′ in FIG. 5, so as to describe a subpixel structure of the UDC area UA.

In FIGS. 5 to 7, a plurality of subpixels provided in the liquid crystal panel 100 may include a red subpixel SP-R displaying red (R), a green subpixel SP-G displaying green (G), a blue subpixel SP-B displaying blue (B), and a white subpixel SP-W displaying white (W).

As illustrated in FIG. 5, in the normal area NMA and the dark area DA, the plurality of subpixels may have the same width and length, and the color arrangement of the subpixels may be equal to one another.

For example, in the normal area NMA and the dark area DA, the plurality of subpixels may be sequentially and repeatedly arranged in a first direction x in the order of the red subpixel SP-R, the green subpixel SP-G, and the blue subpixel SP-B.

In the normal area NMA and the dark area DA, a structure of each of the plurality of subpixels may be equal to each other. For example, as illustrated in FIG. 5, in the normal area NMA and the dark area DA, the width and length of each of the plurality of subpixels may be equal to each other. As illustrated in FIG. 6, in each of the normal area NMA and dark area DA, a cross-sectional structure of each of the plurality of subpixels may be equal to each other.

Accordingly, in terms of a structure, an aperture ratio of each subpixel disposed in the normal area NMA and the dark area DA may be equal to each other.

The number of white subpixels SP-W per unit area provided in the UDC area UA may be more than the number of white subpixels SP-W per unit area provided in the normal area NMA and the dark area DA. For example, the normal area NMA and dark area DA may not include the white subpixel SP-W, and the UDC area UA may include the white subpixel SP-W.

One of the width and length of the white subpixel SP-W provided in the UDC area UA may be greater than one of the width and length of each of the subpixels provided in the normal area NMA and dark area DA. In FIG. 5, a case where the width of some of the white subpixels SP-W provided in the UDC area UA is greater than that of the subpixels provided in the normal area NMA and dark area DA is illustrated as an example.

The white subpixel SP-W provided in the UDC area UA may not include a color filter. For example, in a cross-sectional surface of each of the normal area NMA and dark area DA, as illustrated in FIG. 6, each subpixel may include a color filter. In detail, the red subpixel SP-R may include a red color filter 151R, the green subpixel SP-G may have a green color filter 151G, and the blue subpixel SP-B may have a blue color filter 151B.

However, the UDC area UA may further include the white subpixel SP-W in addition to the red subpixel SP-R, the green subpixel SP-G, and the blue subpixel SP-B. The white subpixel SP-W may not include a color filter as illustrated in FIG. 7.

Accordingly, an area ratio of a white subpixel including no color filter among the plurality of subpixels disposed in the UDC area may be greater than an area ratio of a white subpixel including no color filter among the plurality of subpixels disposed in the normal area and the dark area, and an area occupied by the black matrix per unit area in the UDC area UA may be less than an area occupied by the black matrix per unit area in the normal area NMA and the dark area DA.

Accordingly, in terms of a structure, an aperture ratio of each subpixel disposed in the UDC area UA may be greater than that of each subpixel disposed in the normal area NMA and the dark area DA.

Furthermore, as illustrated in FIG. 7, in the UDC area UA, the R, G, and B subpixels may include color filters, but a color filter may be omitted in white subpixel SP-W. Therefore, in terms of a structure, a transmittance of the liquid crystal panel 100 in the UDC area UA may be greater than that of the liquid crystal panel 100 in the normal area NMA and dark area DA. Accordingly, the present disclosure may more enhance the external light detection capability of the optical module 300.

Moreover, as described above, the normal area NMA may be driven by the main light source PL, and the UDC area UA may be driven by the auxiliary light source AL. Therefore, a visual difference between the normal area NMA and the UDC area UA may be reduced by controlling the brightness of the auxiliary light source AL.

However, in terms of a structure, the subpixels in the dark area DA may have an aperture ratio which is lower than that of the subpixel of the UDC area UA and may not include an optical sheet, and thus, even when the auxiliary light source AL is controlled, a luminance of an image displayed on the dark area DA may differ from that of an image displayed on the UDC area UA and the normal area NMA, causing a visual difference.

The display apparatus according to an example embodiment of the present disclosure may include a multi digital gamma processing unit which may differently process gamma compensation on the normal area NMA and UDC area UA and gamma compensation on the dark area DA, to reduce a visual difference in the dark area DA. This will be described below in detail with reference to FIG. 8.

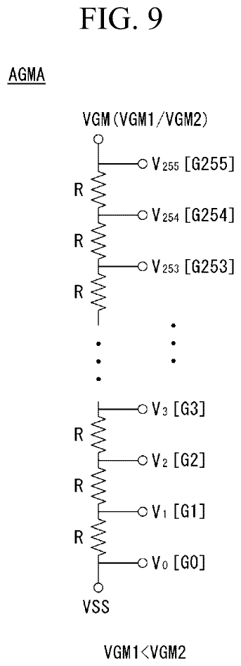

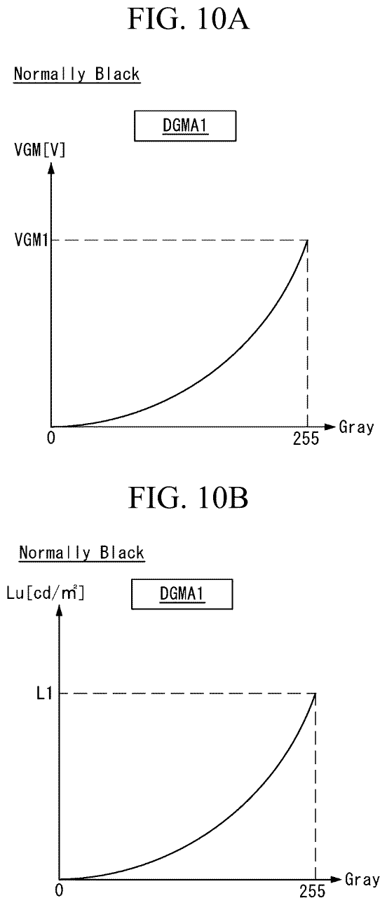

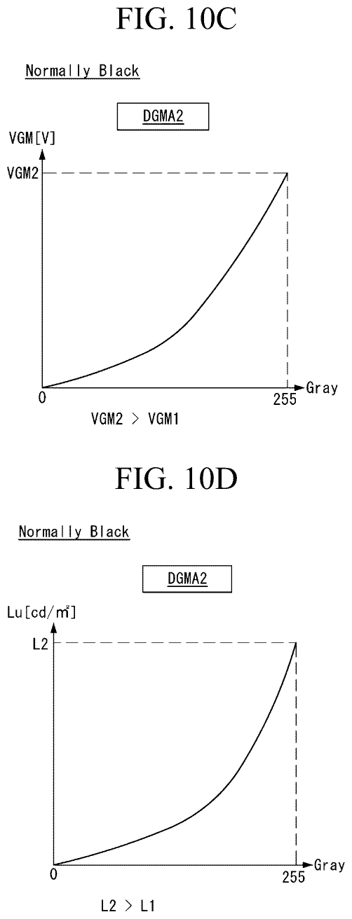

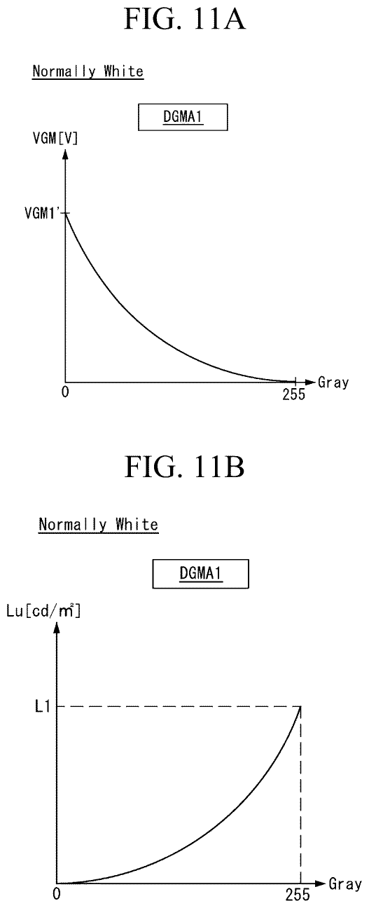

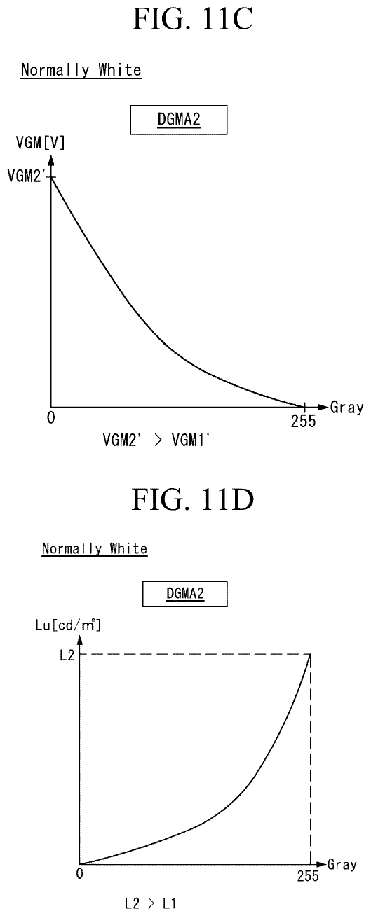

FIG. 8 is a diagram for describing an example of the data driver illustrated in FIG. 1, FIG. 9 is a diagram for describing an example of an analog gamma processing unit illustrated in FIG. 8, FIG. 10A to FIG. 10D are diagrams for describing first and second gamma compensations processed by a multi digital gamma processing unit illustrated in FIG. 8 when the liquid crystal panel operates in the normally black mode, and FIG. 11A to FIG. 11D are diagrams illustrating another example for describing first and second gamma compensations processed by the multi digital gamma processing unit illustrated in FIG. 8 when the liquid crystal panel operates in a normally white mode.

FIG. 8 illustrates an example of the data driver 320, including a diagram for describing an example of the multi digital gamma processing unit M-DGMA.

As illustrated in FIG. 8, the data driver 320 may include an image processing unit 321 and a digital-to-analog converter 323.

The image processing unit 321 may receive digital image data D-DATA from the timing controller 310 and may perform image processing such as gamma compensation to output image data.

The digital-to-analog converter 323 may receive digital image data from the image processing unit 321, may convert the digital image data into the analog data voltage Vdata through the digital-to-analog converter 323, and may output the analog data voltage Vdata to the data line DL connected to the subpixel.

In the display apparatus according to an example embodiment of the present disclosure, the multi digital gamma processing unit M-DGMA may be included in the image processing unit 321, disposed between the timing controller 310 and the analog gamma processing unit AGMA.

In detail, the image processing unit 321 may include a camera pattern compensation unit CPC, the multi digital gamma processing unit M-DGMA, an error diffusion unit ED, and an over-driver OD. The image processing unit 321 illustrated in FIG. 8 illustrates only some of various function blocks, and the image processing unit 321 according to an example embodiment of the present disclosure is not limited to the illustration of FIG. 8.

When smear occurs in an image captured by a camera, the camera pattern compensation unit CPC may correct the smear to remove the smear.

The multi digital gamma processing unit M-DGMA may differently perform gamma compensation on a data voltage supplied to the subpixel disposed in the dark area DA and gamma compensation on a data voltage supplied to the subpixel disposed in the normal area NMA and the UDC area UA to compensate for low luminance in the dark area DA, thereby reducing or suppressing a visual difference and a sense of difference in an image displayed on the dark area DA.

The error diffusion unit ED may distribute errors, caused by a limitation of the number of bits, to adjacent pixels by pixel units when the number of colors and gray levels of the liquid crystal panel 100 is insufficient. That is, under a condition where gray expression is limited, the error diffusion unit ED may distribute errors so that an image displayed through the liquid crystal panel 100 is seen to be visually nature. For example, when input gamma-corrected digital image data is 14 bits, the error diffusion unit ED may down-convert dithered digital image data into 8-bit to output 8-bit data, based on a limitation of number of gray levels of the liquid crystal panel 100.

The over-driver OD may predict a difference between a previous frame and a next frame to overshoot the analog data voltage Vdata supplied to a corresponding subpixel, thereby reducing image-sticking.

The multi digital gamma processing unit M-DGMA according to an example embodiment of the present disclosure may be disposed between the camera pattern compensation unit CPC and the error diffusion unit ED, in the image processing unit 321. Accordingly, an optical compensation result obtained through luminance and color coordinate compensation may be prevented or suppressed from being affected by gamma compensation performed by the multi digital gamma processing unit M-DGMA.

Moreover, FIG. 8 illustrates an example where the data driver 320 includes the multi digital gamma processing unit M-DGMA provided between the camera pattern compensation unit CPC and the error diffusion unit ED, but depending on the case, instead of the multi digital gamma processing unit M-DGMA, a first digital gamma processing unit DGMA1 may be included in the data driver 320.

For example, when the data driver 320 supplies data voltage to only the normal area NMA, the data driver 320 may include the first digital gamma processing unit DGMA1 instead of the multi digital gamma processing unit M-DGMA, and when the data driver 320 supplies a data voltage to the dark area DA along with the normal area NMA or the UDC area UA, the data driver 320 may include the multi digital gamma processing unit M-DGMA as illustrated in FIG. 8.

The data driver 320 may be implemented in the form of a plurality of data drive ICs, and based on a position at which each data drive IC is connected to the liquid crystal panel 100, the multi digital gamma processing unit M-DGMA may be included in some data drive ICs, and the first digital gamma processing unit DGMA1 instead of the multi digital gamma processing unit M-DGMA may be included in some other data drive ICs.

For example, when the data drive IC supplies a data signal to only the normal area NMA, the first digital gamma processing unit DGMA1 may be included in the image processing unit 321, and when the data drive IC supplies data signals to the normal area NMA, the dark area DA, and the UDC area UA, the multi digital gamma processing unit M-DGMA may be included in the image processing unit 321.

The multi digital gamma processing unit M-DGMA, as illustrated in FIG. 8, may include a branch switch DeMux, the first digital gamma processing unit DGMA1, a second digital gamma processing unit DGMA2, and a selection switch Mux.

Based on a position of a subpixel on which digital image data output from the camera pattern compensation unit CPC is to be displayed, the branch switch DeMux may allow corresponding digital image data to be input to the first digital gamma processing unit DGMA1 or the second digital gamma processing unit DGMA2, based on a first control signal CS1.

For example, when the digital image data output from the camera pattern compensation unit CPC is data supplied to a subpixel disposed in the normal area NMA or the UDC area UA, the branch switch DeMux may be switched based on the first control signal CS1 so that corresponding digital image data is input to the first digital gamma processing unit DGMA1.

Moreover, when the digital image data output from the camera pattern compensation unit CPC is data supplied to a subpixel disposed in the dark area DA, the branch switch DeMux may be switched based on the first control signal CS1 so that the digital image data is input to the second digital gamma processing unit DGMA2.

The first digital gamma processing unit DGMA1 may perform first gamma compensation on digital image data supplied to subpixels disposed in the normal area NMA and the UDC area UA, and the second digital gamma processing unit DGMA2 may perform second gamma compensation on digital image data supplied to subpixels disposed in the dark area DA.

Hereinafter, digital image data on which first gamma compensation has been performed in the first digital gamma processing unit DGMA1 may be referred to as first image data Vd1, and digital image data on which second gamma compensation has been performed in the second digital gamma processing unit DGMA2 may be referred to as second image data Vd2.

A range from a minimum voltage to a maximum voltage in the first image data Vd1 which is output by the first digital gamma processing unit DGMA1 and is based on the first gamma compensation may differ from a range from a minimum voltage to a maximum voltage in the second image data Vd2 which is output by the second digital gamma processing unit DGMA2 and is based on the second gamma compensation.

For example, a maximum voltage VGM1 of the first image data Vd1 which is output by the first digital gamma processing unit DGMA1 and is based on the first gamma compensation may be less than a maximum voltage VGM2 of the second image data Vd2 which is output by the second digital gamma processing unit DGMA2 and is based on the second gamma compensation.

Accordingly, the display apparatus according to an example embodiment of the present disclosure may allow a luminance of a maximum gray level of the first image data Vd1 based on the first gamma compensation to be less than a luminance of a maximum gray level of the second image data Vd2 based on the second gamma compensation. Accordingly, the display apparatus according to an example embodiment of the present disclosure may reduce or suppress a visual difference and a sense of difference between the brightness of an image displayed on the dark area DA and the brightness of an image displayed on the UDC area UA and the normal area NMA.

That is, the present disclosure may perform first gamma compensation through the first digital gamma processing unit DGMA1 to decrease a luminance of an image displayed on the UDC area UA and the normal area NMA and may perform second gamma compensation through the second digital gamma processing unit DGMA2 to increase a luminance of an image displayed on the dark area DA. Accordingly, the present disclosure may minimize or reduce a difference between the brightness of the dark area DA and the brightness of the UDC area UA and the normal area NMA, thereby reducing or suppressing a visual difference and a sense of difference in an image.

The selection switch Mux may be disposed at a rear end of each of the first and second digital gamma processing units DGMA1 and DGMA2 and may selectively output one of an output of the first digital gamma processing unit DGMA1 and an output of the second digital gamma processing unit DGMA2 to the error diffusion unit ED, based on the second control signal CS2.

That is, when the first digital gamma processing unit DGMA1 performs the first gamma compensation, the selection switch Mux may allow the first image data Vd1, on which the first gamma compensation has been processed, to be output to the digital-to-analog converter 323 through the error diffusion unit ED.

Moreover, when the second digital gamma processing unit DGMA2 performs the second gamma compensation, the selection switch Mux may allow the second image data Vd2, on which the second gamma compensation has been processed, to be output to the digital-to-analog converter 323 through the error diffusion unit ED.

The digital-to-analog converter 323 may include an analog gamma processing unit AGMA and a buffer BF.

The analog gamma processing unit AGMA, as illustrated in FIG. 9, may set a minimum-maximum voltage range VSS to VGM based on gamma compensation processed in the multi digital gamma processing unit M-DGMA and may output a data voltage divided within the set minimum-maximum voltage range VSS to VGM. Accordingly, the analog gamma processing unit AGMA may receive image data and convert the image data into an analog data voltage Vdata corresponding to a gray level of the image data to output the analog data voltage Vdata.

The buffer BF may stabilize the analog data voltage Vdata output from the analog gamma processing unit AGMA and may output the analog data voltage Vdata to a plurality of subpixels through the data line DL. For example, the buffer BF may supply the analog data voltage Vdata to subpixels of the normal area NMA, subpixels of the dark area DA, and subpixels of the UDC area UA in synchronization with the scan signal SC supplied from the scan driver 330.

For example, when the multi digital gamma processing unit M-DGMA outputs the first image data Vd1 on which the first gamma compensation has been performed by the first digital gamma processing unit DGMA1, a minimum-maximum voltage range of the analog gamma processing unit AGMA may be VSS to VGM1. When the multi digital gamma processing unit M-DGMA outputs the second image data Vd2 on which the second gamma compensation has been performed by the second digital gamma processing unit DGMA2, a minimum-maximum voltage range of the analog gamma processing unit AGMA may be VSS to VGM2.

Here, the maximum voltage VGM1 may have a voltage level which is relatively lower than the maximum voltage VGM2. Therefore, even when the first and second image data Vd1 and Vd2 have the same gray level, because the maximum voltages set in the analog gamma processing unit AGMA differ, the analog data voltage Vdata of the first image data Vd1 may have a voltage level which is lower than the analog data voltage Vdata of the second image data Vd2.

For example, when the analog gamma processing unit AGMA receives the first image data Vd1 of 253 gray level on which the first gamma compensation has been performed, a maximum voltage of the analog gamma processing unit AGMA may be set to VGM1, and the analog gamma processing unit AGMA may output a data voltage V253 corresponding to the 253 gray level of the first image data Vd1.

Moreover, when the analog gamma processing unit AGMA receives the second image data Vd2 of 253 gray level on which the second gamma compensation has been performed, a maximum voltage of the analog gamma processing unit AGMA may be set to VGM2, and the analog gamma processing unit AGMA may output a data voltage V253 corresponding to the 253 gray level of the second image data Vd2.

However, the data voltage V253 of the second image data Vd2 may have a voltage level which is higher than the data voltage V253 of the first image data Vd1. That is, even when the first and second image data Vd1 and Vd2 have the same gray level, the analog data voltage Vdata of the second image data Vd2 may differ from the analog data voltage Vdata of the first image data Vd1.

In more detail, as illustrated in FIG. 10A to FIG. 10D, in a case where the liquid crystal panel 100 operates in the normally black mode, and the multi digital gamma processing unit M-DGMA may output the first image data Vd1 on which the first gamma compensation has been performed by the first digital gamma processing unit DGMA1, as illustrated in FIG. 10A, a maximum voltage (for example, when 255 gray level) set in the analog gamma processing unit AGMA based on the first gamma compensation may be VGM1, and as illustrated in FIG. 10B, maximum luminance (for example, when 255 gray level) which may be output based on the maximum voltage VGM1 set in the analog gamma processing unit AGMA may be L1.

However, when the multi digital gamma processing unit M-DGMA outputs the second image data Vd2 on which the second gamma compensation has been performed by the second digital gamma processing unit DGMA2, as illustrated in FIG. 10C, a maximum voltage set in the analog gamma processing unit AGMA (for example, 255 gray level) may be VGM2, which is greater than VGM1, and as illustrated in FIG. 10D, maximum luminance (for example, when 255 gray level) which may be output based on the maximum voltage VGM2 set in the analog gamma processing unit AGMA may be L2 which is greater than L1.

Moreover, as illustrated in FIG. 11A to FIG. 11D, in a case where the liquid crystal panel 100 operates in the normally white mode, when the multi digital gamma processing unit M-DGMA outputs the first image data Vd1 on which first gamma compensation has been performed by the first digital gamma processing unit DGMA1, as illustrated in FIG. 11A, a maximum voltage set in the analog gamma processing unit AGMA (for example, when 0 gray level) based on the first gamma compensation may be VGM1′, and as illustrated in FIG. 11B, maximum luminance (for example, when 255 gray level) which may be output based on the maximum voltage VGM1′ set in the analog gamma processing unit AGMA may be L1.

However, when the multi digital gamma processing unit M-DGMA outputs the second image data Vd2 on which the second gamma compensation has been performed by the second digital gamma processing unit DGMA2, as illustrated in FIG. 11C, a maximum voltage set in the analog gamma processing unit AGMA (for example, when 0 gray level) may be VGM2′ which is greater than VGM1′, and as illustrated in FIG. 11D, maximum luminance (for example, when 255 gray level) which may be output based on the maximum voltage VGM2′ set in the analog gamma processing unit AGMA may be L2 which is greater than L1.

Accordingly, the present disclosure may output the second image data Vd2 on which the second gamma compensation has been performed, based on the second digital gamma processing unit DGMA2, and thus, may increase a luminance of an image displayed on the dark area DA, thereby reducing or suppressing a visual difference and a sense of difference occurring between an image displayed on the dark area DA and an image displayed on the normal area NMA and UDC area UA.

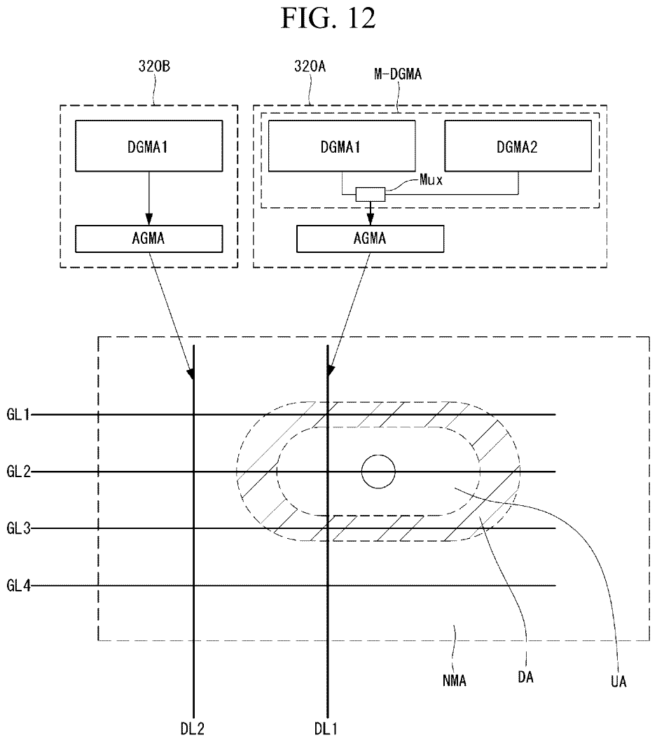

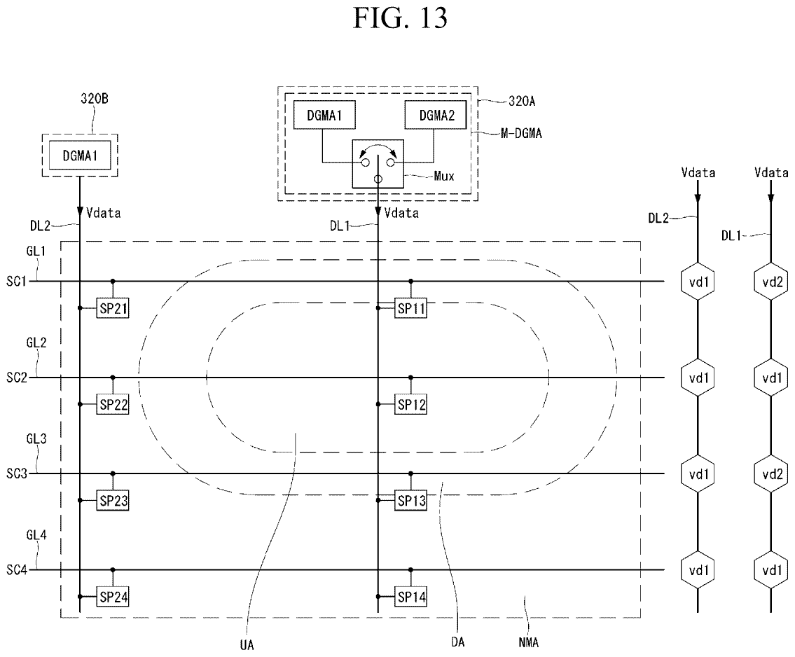

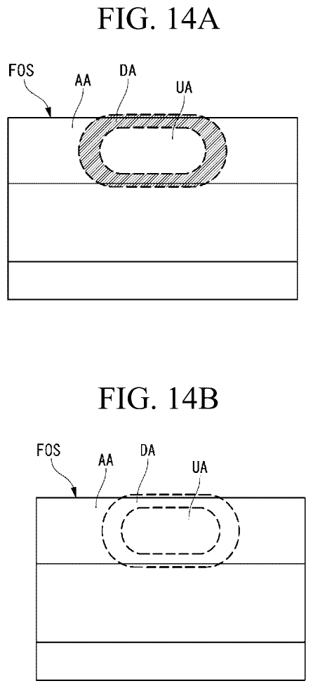

FIG. 12 is a diagram for describing an example of each of first and second data drivers differently provided based on positions connected to the liquid crystal panel illustrated in FIG. 1, FIG. 13 is a diagram for describing an example of image data supplied by the first and second data drivers illustrated in FIG. 12, and FIG. 14 is a diagram for describing an effect of a multi digital gamma processing unit provided in the present disclosure.

As described above, the data driver 320 may be implemented by a plurality of data drive ICs. For example, the plurality of data drive ICs may include a first data drive IC 320A and a second data drive IC 320B.

The first data drive IC 320A may supply an analog data voltage Vdata to a plurality of subpixels disposed in the dark area DA, the UDC area UA, and the normal area NMA through a first data line DL1, and the second data drive IC 320B may supply the analog data voltage Vdata to the plurality of subpixels disposed in the normal area NMA through a second data line DL2.

The first data drive IC 320A may include a multi digital gamma processing unit M-DGMA, including first and second digital gamma processing units DGMA1 and DGMA2, and an analog gamma processing unit AGMA. The second data drive IC 320B, unlike the first data drive IC 320A, may include the first digital gamma processing unit DGMA1 instead of the multi digital gamma processing unit M-DGMA. That is, the second data drive IC 320B may not include the second digital gamma processing unit DGMA2.

In FIG. 12, for convenience of description, a case where the digital gamma processing unit and the analog gamma processing unit AGMA are included in the first and second data drive ICs 320A and 320B is briefly illustrated, but embodiments of the present disclosure are not limited thereto and various other function blocks for image processing may be freely added to the first and second data drive ICs 320A and 320B.

The second data drive IC 320B may generate first gamma-compensated first image data Vd1 through the first digital gamma processing unit DGMA1, may convert the first image data Vd1 into an analog data voltage Vdata through the analog gamma processing unit AGMA, and may supply the analog data voltage Vdata based on the first image data Vd1 to the plurality of subpixels disposed in the normal area NMA through the second data line DL2.

The first data drive IC 320A may generate the first gamma-compensated first image data Vd1 through the first digital gamma processing unit DGMA1, may convert the first image data Vd1 into the analog data voltage Vdata through the analog gamma processing unit AGMA, and may supply the analog data voltage Vdata based on the first image data Vd1 to the plurality of subpixels disposed in the UDC area UA and the normal area NMA through the first data line DL1.

As described above, the first digital gamma processing unit DGMA1 of the first data drive IC 320A may perform the first gamma compensation like the first digital gamma processing unit DGMA1 of the second data drive IC 320B.

Moreover, the first data drive IC 320A may generate second gamma-compensated second image data Vd2 through the second digital gamma processing unit DGMA2, may convert the second image data Vd2 into the analog data voltage Vdata through the analog gamma processing unit AGMA, and may supply the analog data voltage Vdata based on the second image data Vd2 to the plurality of subpixels disposed in the dark area DA through the first data line DL1.

This will be described below in more detail with reference to FIG. 13. For reference, for convenience of understanding, the illustration of the analog gamma processing unit AGMA is omitted.

As illustrated in FIG. 13, the first data line DL1 may be connected to subpixels SP12 disposed in the UDC area UA, subpixels SP11 and SP13 disposed in the dark area DA, and subpixels SP14 disposed in the normal area NMA. The second data line DL2 may be connected to a plurality of subpixels SP21 to SP24 disposed in the normal area NMA. A first scan line GL1 may be connected to the subpixels SP21 and SP11, and a second scan line GL2 may be connected to the subpixels SP22 and SP12, a third scan line GL3 may be connected to the subpixels SP23 and SP13, and a fourth scan line GL4 may be connected to the subpixels SP24 and SP14.

When a first scan signal SC1 is supplied to the first scan line GL1, the second data drive IC 320B may supply the analog data voltage Vdata of the first gamma-compensated first image data Vd1 to the subpixel SP21 through the first digital gamma processing unit DGMA1 in response to the first scan signal SC1, and the first data drive IC 320A may supply the analog data voltage Vdata of the second gamma-compensated second image data Vd2 to the subpixel SP11 through the second digital gamma processing unit DGMA2 in response to the first scan signal SC1.

When a second scan signal SC2 is supplied to the second scan line GL2, the first and second data drive ICs 320A an 320B may respectively supply the analog data voltage Vdata of the first gamma-compensated first image data Vd1 to the subpixels SP22 and SP12 through the first digital gamma processing unit DGMA1 in response to the second scan signal SC2.

When a third scan signal SC3 is supplied to the third scan line GL3, the second data drive IC 320B may supply the analog data voltage Vdata of the first gamma-compensated first image data Vd1 to the subpixels SP23 through the first digital gamma processing unit DGMA1 in response to the third scan signal SC3, and the first data drive IC 320A may supply the analog data voltage Vdata of the second gamma-compensated second image data Vd2 to the subpixel SP13 through the second digital gamma processing unit DGMA2 in response to the third scan signal SC3.

When a fourth scan signal SC4 is supplied to the fourth scan line GL4, the first and second data drive ICs 320A and 320B may respectively supply the analog data voltage Vdata of the first gamma-compensated first image data Vd1 to the subpixels SP24 and SP14 through the first digital gamma processing unit DGMA1 in response to the fourth scan signal SC4.

When the first scan signal SC1 or the third scan signal SC3 is supplied, even in a case where gray levels of the first and second image data Vd1 and Vd2 are equal to each other, the analog data voltage Vdata based on the second image data Vd2 may differ from the analog data voltage Vdata based on the first image data Vd1.

Therefore, even when the gray levels of the first and second image data Vd1 and Vd2 are equal to each other, a transmittance of the liquid crystal layer LC of a subpixel supplied with a data voltage of the first image data Vd1 may differ from that of the liquid crystal layer LC of a subpixel supplied with a data voltage of the second image data Vd2.

As described above, comparing with the normal area NMA and the UDC area UA, the present disclosure may allow another gamma compensation to be performed on the dark area DA through the first and second digital gamma processing units DGMA1 and DGMA2 of the multi digital gamma processing unit M-DGMA, and thus, may relatively increase a luminance of the dark area DA, thereby reducing or suppressing a visual difference and a sense of difference.

FIG. 14A illustrates an image displayed on the liquid crystal panel 100 when the multi digital gamma processing unit M-DGMA according to an example embodiment of the present disclosure is not provided, and FIG. 14B illustrates an image displayed on the liquid crystal panel 100 when the multi digital gamma processing unit M-DGMA according to an example embodiment of the present disclosure is provided.

For example, FIG. 14A may represent a case where the first and second data drive ICs 320A and 320B described with reference to FIG. 13 include only the first digital gamma processing unit DGMA1.

In a case where the same gamma compensation is performed on the dark area DA, the UDC area UA, and the normal area NMA, as in FIG. 14A, the dark area DA may be displayed relatively darker than the UDC area UA and the normal area NMA, based on an aperture ratio difference of the liquid crystal panel 100 and whether there is a diffusion sheet and the reflector 230.

However, as in the present disclosure, in a case where the multi digital gamma processing unit M-DGMA is provided, as in FIG. 14B, comparing with the UDC area UA and the normal area NMA, another gamma compensation may be performed on the dark area DA, and thus, a luminance of the dark area DA may increase, thereby reducing or suppressing a visual difference and a sense of difference in an image displayed on the dark area DA.

As described above, the display apparatus according to an example embodiment of the present disclosure may include the first digital gamma processing unit DGMA1 which performs the first gamma compensation on subpixels disposed in the normal area NMA and the UDC area UA and the second digital gamma processing unit DGMA2 which performs the second gamma compensation on subpixels disposed in the dark area DA, and thus, may improve a luminance of the dark area DA which is relatively darkly displayed compared to the normal area NMA and the UDC area UA, based on the second digital gamma processing unit DGMA2, thereby reducing or suppressing a visual difference and a sense of difference in an image displayed on the dark area DA.

In more detail, the display apparatus according to an example embodiment of the present disclosure may provide, through the second digital gamma processing unit DGMA2, a luminance of a maximum gray level which is greater than a luminance of a maximum gray level of the first digital gamma processing unit DGMA1, thereby reducing or suppressing a visual difference and a sense of difference in an image displayed on the dark area DA.

The display apparatus according to an example embodiment of the present disclosure may include a first digital gamma processing unit which performs first gamma compensation on subpixels disposed in a normal area and a UDC area and a second digital gamma processing unit which performs second gamma compensation on subpixels disposed in a dark area, and thus, may compare the normal area with the UDC area through the second digital gamma processing unit to improve a luminance of the dark area relatively darkly displayed compared to the normal area and the UDC area by using the second digital gamma processing unit, thereby reducing or suppressing a sense of difference and a visual difference of an image displayed on the dark area.

In more detail, the display apparatus according to an example embodiment of the present disclosure may allow a luminance of a maximum gray level, which is greater than a luminance of a maximum gray level provided through the first digital gamma processing unit, to be provided through the second digital gamma processing unit, thereby suppressing or reducing a sense of difference and a visual difference of an image displayed on the dark area.

The effects according to the present disclosure are not limited to the above examples, and other various effects may be included in the specification.

While the present disclosure has been particularly shown and described with reference to example embodiments thereof, it will be understood by those of ordinary skill in the art that various changes in form and details may be made therein without departing from the spirit and scope of the present disclosure as defined by the following claims.

What is claimed is:

1. A display apparatus, comprising:
a liquid crystal panel including a normal area and a dark area and an under-camera display (UDC) area disposed to be surrounded by the normal area, a plurality of subpixels being provided in each of the normal area, the dark area, and the UDC area;
an optical sheet disposed on a backside surface of the liquid crystal panel and including a sheet hole passing through the optical sheet to correspond to the dark area;
a backlight light guide plate disposed on a backside surface of the optical sheet and configured to supply light of a main light source disposed therein to the liquid crystal panel;
a reflector disposed on a backside surface of the backlight light guide plate and including a reflector hole with an open portion corresponding to the UDC area;
an optical module disposed on a backside surface of the reflector and configured to detect external light through the reflector hole; and
a data driver configured to supply a data voltage based on digital image data to the plurality of subpixels in response to a scan signal,
wherein the data driver comprises a multi digital gamma processing unit including a first digital gamma processing unit configured to perform first gamma compensation on a data signal supplied to a subpixel disposed in each of the normal area and the UDC area, among the plurality of subpixels, to output first image data and a second digital gamma processing unit configured to perform second gamma compensation on a data signal supplied to a subpixel disposed in the dark area, among the plurality of subpixels, to output second image data.

2. The display apparatus of claim 1, wherein the data driver further comprises an analog gamma processing unit, a range from a minimum voltage to a maximum voltage of the analog gamma processing unit on the first image data based on the first gamma compensation differs from a range from a minimum voltage to a maximum voltage of the analog gamma processing unit on the second image data based on the second gamma compensation.

3. The display apparatus of claim 1, wherein a maximum voltage of the first image data based on the first gamma compensation is less than a maximum voltage of the second image data based on the second gamma compensation.

4. The display apparatus of claim 1, wherein a luminance of a maximum gray level of the first image data based on the first gamma compensation is less than a luminance of a maximum gray level of the second image data based on the second gamma compensation.

5. The display apparatus of claim 1, wherein an aperture ratio of the subpixel disposed in the UDC area is greater than an aperture ratio of the subpixel disposed in each of the normal area and the dark area.

6. The display apparatus of claim 1, wherein an aperture ratio of the subpixel disposed in the dark area is equal to an aperture ratio of the subpixel disposed in the normal area.

7. The display apparatus of claim 1, wherein an area ratio of a white subpixel including no color filter among the plurality of subpixels disposed in the UDC area is greater than an area ratio of a white subpixel including no color filter among the plurality of subpixels disposed in the normal area and the dark area.

8. The display apparatus of claim 1, further comprising an auxiliary light source disposed on the backside surface of the reflector and configured to supply light at least to the UDC area among the normal area, the UDC area, and the dark area.

9. The display apparatus of claim 8, wherein brightness of the main light source is set based on the dark area so that a maximum gray level of the subpixel disposed in the dark area has luminance which is previously set.

10. The display apparatus of claim 9, wherein brightness of the auxiliary light source is set so that a luminance of a maximum gray level of the subpixel disposed in the UDC area is equal to a luminance of a maximum gray level, set by the main light source, of the subpixel disposed in the normal area.

11. The display apparatus of claim 1, wherein the multi digital gamma processing unit is included in an image processing unit disposed between a timing controller configured to output digital image data and an analog gamma processing unit configured to convert the digital image data into an analog data voltage.

12. The display apparatus of claim 11, wherein the multi digital gamma processing unit is disposed between a camera pattern compensation unit configured to compensate for display smear when capturing an image with a camera and an error diffusion unit configured to distribute errors, caused by a limitation of a number of bits, to adjacent pixels.

13. The display apparatus of claim 1, further comprising a selection switch disposed at a rear end of each of the first and second digital gamma processing units and configured to select one output from among an output of the first digital gamma processing unit and an output of the second digital gamma processing unit.

14. The display apparatus of claim 1, wherein:
the data driver is configured to supply a data voltage based on the first image data or a data voltage based on the second image data through a first data line,
the data driver is configured to output, through the first data line, the data voltage based on the first image data to the subpixel disposed in the UDC area in response to a first scan signal,
the data driver is configured to output, through the first data line, the data voltage based on the second image data to the subpixel disposed in the dark area in response to a second scan signal, and
the data driver is configured to output, through the first data line, the data voltage based on the first image data to the subpixel disposed in the normal area in response to a third scan signal.

15. The display apparatus of claim 1, wherein, when gray levels of the first and second image data are equal to each other, a data voltage based on the second image data differs from a data voltage based on the first image data.
